(19) United States
(12) Patent Application Publication
(10) Pub. No.: US 2023/0171849 A1
(43) Pub. Date: Jun. 1, 2023

(54) SOFTSENSOR ANALYSIS AND MEASUREMENT SYSTEM TO PROVIDE THE OUTPUT BY NEW PROGRESS VARIABLES BASED ON COLLECTED DATA FROM A SORT OF SENSORS

(71) Applicant: MIRAE CIT Inc., Seoul (KR)

(72) Inventors: Wontae KIM, Seoul (KR); Dae Hwan Kim, Seoul (KR)

(73) Assignee: MIRAE CIT Inc., Seoul (KR)

(21) Appl. No.: 17/975,197

(22) Filed: Oct. 27, 2022

(30) Foreign Application Priority Data
Nov. 26, 2021 (KR) 10-2021-0165826

(51) Int. Cl. H04W 84/18; G16Y 40/35; G16Y 20/10; G16Y 40/20

(52) U.S. Cl. CPC H04W 84/18; G16Y 40/35; G16Y 20/10; G16Y 40/20; G16Y 10/25

(57) ABSTRACT

Provided is a softsensor analysis and measurement system to provide the output by new progress variables based on collected data by a sort of sensors. The system comprises: an online sensor, an inline sensor, or an offline sensor; a machine learning/deep learning module; and a soft sensor server for collecting and storing online sensor data collected by the on-line sensor through a sensor network and a gateway, Ethernet, or WLAN (Wi-Fi), collecting and storing inline sensor data measured by an IoT device equipped with the inline sensor or offline sensor data measured by the offline sensor through an analysis device (dedicated analyzer), and outputting a result by applying new process variables (input) of a manufacturing process by using the machine learning/deep learning module, and feeding back and applying the new process variables of the manufacturing process to a control computer of the manufacturing process.

### CROSS-REFERENCE TO RELATED APPLICATION

This application claims priority to Korean Patent Application No. 10-2021-0165826, filed on Nov. 26, 2021, the disclosures of which is herein incorporated by reference in its entirety.

This application was supported by a grant of the National IT Industry Promotion Agency (NIPA, No. A1308-22-1008).

### FIELD OF THE INVENTION

The present invention relates to a soft sensor analysis and measurement system, and more particularly, to a softsensor analysis and measurement system for deriving a result by new process variables on the basis of data collected by various sensors, which collects and stores data collected by various sensors, such as online sensors (temperature sensors, humidity sensors, or pressure sensors, etc.), inline sensors (sensors attached to IoT devices), offline sensors (analysis devices, or dedicated analyzers), and the like, in a softsensor server, and outputs result by new process variables (input) (temperature, humidity, or pressure, etc.) of a manufacturing process by using a machine learning/deep learning module.

### BACKGROUND OF THE INVENTION

Recently, a sensor network system collects sensor data acquired by various sensors through a sensor network and stores the sensor data in a server. The sensor network system may be consisted of a sink node 100, a representative node 200, and a sensor node 300. In the sensor network system, sensor nodes periodically transmit the acquired sensor data to the sink node to transmit the sensor data to a server.

As prior art 1 related thereto, “Sensor network system and method for processing sensor data” is registered as Korean Patent Registration No. 10-2191427 (Registration date: Dec. 9, 2020).

The sensor network system includes: a sink node for acquiring a prediction value by performing the same prediction algorithm as the prediction algorithm performed by a sensor node, updating the prediction value as the sensing value and collecting the sensing value as sensor data when a sensing value is received from the sensor node, determining whether the sensor node is a representative node or not when a sensing value is not received, collecting the prediction value as sensor data when the sensor node is a representative node, correcting the prediction value, when the sensor node is not a representative node, on the basis of a sensing value of the representative node of a cluster to which the sensor node belongs and collecting the collected prediction value as sensor data; a representative node for acquiring a sensing value of the representative node through sensing, acquiring a prediction value of the representative node by performing the prediction algorithm, determining either whether the amount of change in the sensing value of the representative node is greater than or equal to a threshold value or whether the difference between the prediction value of the representative node and the sensing value is greater than or equal to a threshold value by the prediction algorithm, transmitting the sensing value of the representative node to the sink node in accordance with a comparison result, and transmitting the sensing value of the representative node to sensor nodes in the cluster to which the representative node belongs when the sensing value of the representative node is transmitted to the sink node; and a sensor node for acquiring a sensing value of the sensor node through sensing, acquiring a prediction value of the sensor node by performing the prediction algorithm, correcting the prediction value of the sensor node on the basis of the sensing value of the representative node when the sensing value of the representative node is received, determining either whether the amount of change in the sensing value of the sensor node is greater than or equal to a threshold value or whether the difference between the corrected prediction value of the sensor node and the sensing value of the sensor node is greater than or equal to a threshold value by the prediction algorithm, and transmitting the sensing value of the sensor node to the sink node in accordance with a comparison result.

However, the prior art does not provide a system for collecting and storing measurement values of online sensors (temperature sensors, humidity sensors, pressure sensors), inline sensors, and offline sensors (analysis devices, dedicated analyzers) in the server, and predicting a modeling result value in accordance with new process variables (input) in a biopharmaceutical process, a smart factory manufacturing process, a food manufacturing process, and a steel manufacturing process.
(Patent Document 1) Korean Patent Registration No. 10-2191427 (Registration Date: Dec. 9, 2020), “Sensor network system and method for processing sensor data”, Electronics and Telecommunications Research Institute

### SUMMARY OF THE INVENTION

To solve the above-described problems in the related art, and an object of the present invention is to provide a softsensor analysis and measurement system for deriving a result by new process variables (input) on the basis of data collected by various sensors, which collects and stores sensor data collected by various sensors, such as online sensors (temperature sensors, humidity sensors, or pressure sensors, etc.), inline sensors (sensors attached to IoT devices), offline sensors (analysis devices, dedicated analyzers), and the like, in a softsensor server, and outputs result in accordance with new process variables (input) of a manufacturing process by using a machine learning/deep learning module.

To accomplish the above object of the present invention, there is provided a softsensor analysis and measurement system for deriving a result by new process variables on the basis of data collected by various sensors, the system comprising: an online sensor, an inline sensor, or an offline sensor; a machine learning/deep learning module; and a softsensor server for collecting and storing online sensor data collected by the on-line sensor through a sensor network and a gateway, Ethernet, or WLAN (Wi-Fi), collecting and storing inline sensor data measured by an IoT device equipped with the inline sensor and/or offline sensor data measured by the offline sensor through an analysis device or dedicated analyzer, and outputting a result by applying new process variables (input) of a manufacturing process by using the machine learning/deep learning module, and feeding back and applying the new process variables of the manufacturing process to a control computer of the manufacturing process.

A softsensor analysis and measurement system for deriving a result by new process variables on the basis of data collected by various sensors according to the present invention has an effect of collecting and storing data collected by various sensors, such as online sensors (temperature sensors, humidity sensors, pressure sensors, etc.), inline sensors (sensors attached to IoT devices), offline sensors (analysis devices, or dedicated analyzers), and the like, in a softsensor server, outputting a result by new process variables (input) of a manufacturing process by using a machine learning/deep learning module, and feeding back and applying the new process variables of the manufacturing process to a control computer of the manufacturing process.

There is provided a system for collecting and storing measurement values of online sensors (temperature sensors, humidity sensors, pressure sensors, etc.) and offline sensors (analysis devices, dedicated analyzers) in the server, and predicting a machine learning/deep learning modeling result value by new process variables (input) (temperature, humidity, pressure, etc.) in a biopharmaceutical process, a smart factory manufacturing process, a food manufacturing process, and a steel manufacturing process.

### BRIEF DESCRIPTION OF THE DRAWINGS

FIG. 1 is a block diagram showing a conventional sensor network system.

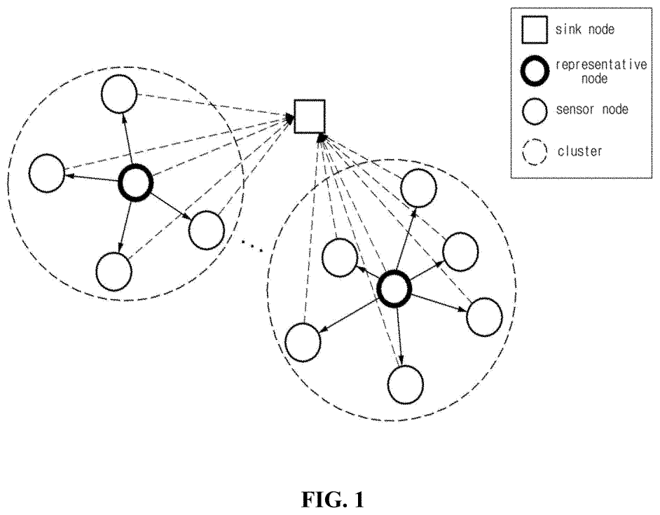

FIG. 2 is a conceptual view showing a soft sensor AI solution using online sensors/inline sensors/offline sensors and a machine learning/deep learning model according to the present invention.

FIG. 3 is a view showing the configuration of a softsensor server that collects online sensor data/inline sensor data/offline sensor data according to the present invention.

FIG. 4 is a view showing the configuration of a softsensor analysis and measurement system according to the present invention.

### DETAILED DESCRIPTION OF THE INVENTION

Hereinafter, preferred embodiments of the present invention will be described in detail with reference to the accompanying drawings. In the description of the present invention, when it is determined that a detailed description of a related known technology or a known configuration may unnecessarily obscure the subject matter of the present invention, the detailed description will be omitted. In addition, when a reference numeral of a drawing indicates the same configuration, the same reference numeral is assigned in different drawings.

The present invention provides a softsensor analysis and measurement system for outputting a result by new process variables (input) on the basis of data collected by various sensors, which collects and stores data collected by various sensors, such as online sensors (temperature sensors, humidity sensors, or pressure sensors, etc.->stores sensor data through a sensor network and a gateway, or through sensor->PLC->industrial computer, in a softsensor server), inline sensors (sensors attached to IoT devices used in a manufacturing process), offline sensors (analysis devices, or dedicated analyzers—for example, HPLC detector of a food manufacturing process: ingredient measurement of a food sample), and the like, in a softsensor server, outputs a result by new process variables (input: temperature, humidity, or pressure, etc.) of a manufacturing process on the basis of a sample, and feeding back and applying the new process variables of the manufacturing process periodically to a control computer of the manufacturing process.

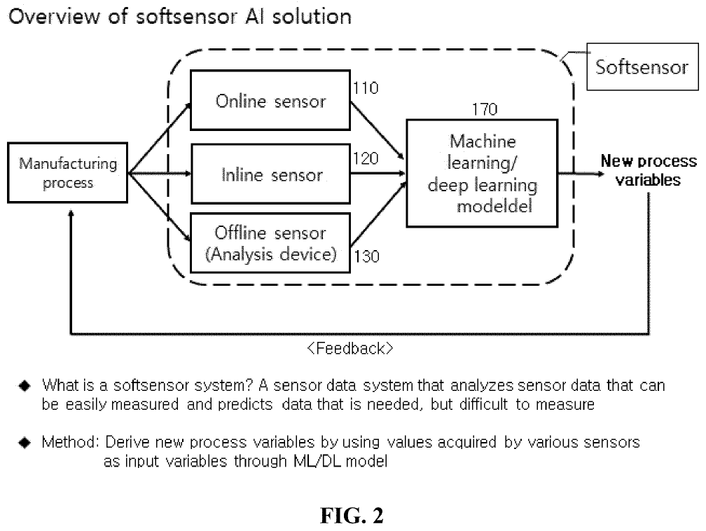

FIG. 2 is a conceptual view showing a soft sensor AI solution using online sensors/inline sensors/offline sensors and a machine learning/deep learning (ML/DL) model according to the present invention.

The concept of applying an online sensor 110, an inline sensor 120, an offline sensor 130, and a machine learning/deep learning model 170 is referred to as a “softsensor”.

The softsensor functions as a virtual sensor for predicting information that is needed but difficult to measure, by analyzing sensor information that is easy to measure.

In the manufacturing process, the softsensor analysis measurement system uses values acquired by various sensors as input variables to derive new process variables (input) of a manufacturing process through a machine learning (ML)/deep learning (DL) model, outputs a result, and feeds back and applies the new process variables again/periodically to a control computer of the manufacturing process.

The softsensor analysis measurement system outputs the result by applying the new process variables (inputs) to a softsensor AI solution by using the online sensor 110, the inline sensor 120, the offline sensor 130, and the machine learning/deep learning model 170, and feeds back the new process variables to a control computer of the manufacturing process to classify normal pattern data and abnormal pattern data of a product.

The deep learning (CNN) or any one selected among several types of machine learning algorithms (ML) is used as the learning algorithm as needed, and any one algorithm among unsupervised-visualization-detection (CNN), unsupervised-advanced control-detection (AutoEncoder), unsupervised-memory-detection (LSTM), deep memory-detection (Deep LSTM), unsupervised-bidirectional-memory-detection (bidirectional LSTM), unsupervised-visualization-memory-detection (convolution LSTM), unsupervised-bidirectional-recurrent-detection (bidirectional GRU), and unsupervised-bidirectional-nested recurrent-detection (stacked bidirectional GRU) algorithms is used as the learning algorithm.

Deep Learning is a type of machine learning (ML) in the AI field. A multi-layered artificial neural network (ANN) is formed between an input and an output, and a convolutional neural network (CNN), a recurrent neural network (RNN), or the like may be used.

Deep learning is used to solve various problems such as classification, regression, localization, detection, segmentation, and the like. Particularly, semantic segmentation and object detection that can determine the locations and types of dynamic and static defects are used important. The semantic segmentation means segmentation into pixel units of the same meaning by performing classification prediction of pixel units in order to detect objects in an image, and through the semantic segmentation, the objects included in an image and even the locations of pixels having the same object may be accurately recognized.

In case of deep learning, object detection in a camera image means classifying and predicting a type of objects in the image, and finding location information of the object by performing a regression prediction on a bounding box, and unlike simple classification of objects in an image, a type of objects in a video or image, as well as location information of the object, may be recognized through the object detection.

Object detection in a camera image is a field that is most frequently used in the field of sensor and computer vision research, and is applied machine learning/deep learning in various fields such as CCTV camera monitoring, smart factory manufacturing process, and the like.

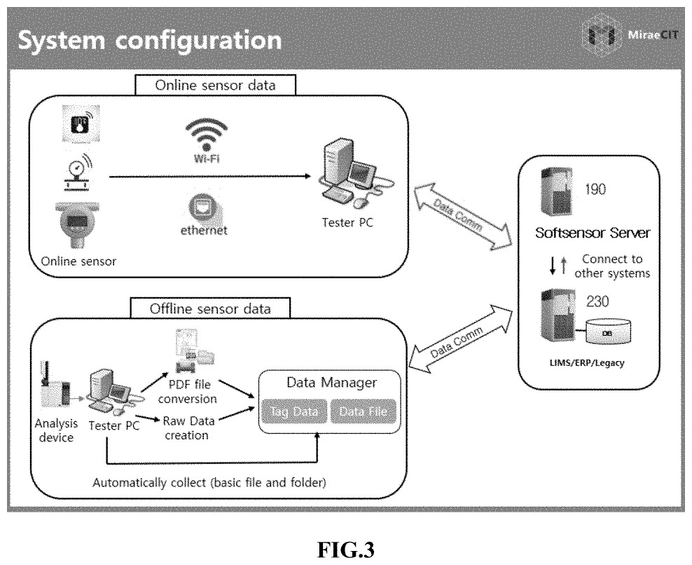

FIG. 3 is a view showing the configuration of a soft sensor server that collects online sensor data/inline sensor data/offline sensor data according to the present invention.

The softsensor analysis and measurement system for deriving a result by new process variables on the basis of data collected by various sensors according to the present invention includes: an online sensor 110, an inline sensor 120, and/or an offline sensor 130; a machine learning/deep learning module 170 interworking with online sensor data, inline sensor data, and offline sensor data; and a softsensor server 190 for collecting and storing the online sensor data collected by the on-line sensor 110 through a sensor network (USN, WSN, 6LoWPA, or ZigBee sensor network, etc.), Ethernet, or WLAN (Wi-Fi), collecting and storing the inline sensor data measured by an IoT device equipped with the inline sensor 120 and/or offline sensor data measured by the offline sensor 130 through an analysis device or dedicated analyzer, and outputting a result by applying new process variables (input) of a manufacturing process by using the machine learning/deep learning module 170, and feeding back the new process variables periodically to a control computer of the manufacturing process. The online sensor 110 includes temperature sensor, humidity sensor, or pressure sensor, etc., and is stored online sensor data collected by the on-line sensor 110 through a sensor network and a gateway or through an online sensor->a PLC->an industrial computer, in the softsensor server 190. The inline sensor 120 includes a sensor attached to an IoT device used in the manufacturing process, and the offline sensor 130 includes an analysis device (measurement device) or a dedicated analyzer. Through sensor data, normal pattern data and abnormal pattern data of a product in the manufacturing process are statistically classified.

The softsensor server 190 collects online sensor data, inline sensor data, and offline sensor data, outputs a result by re-applying new process variables (input) of the manufacturing process by using the machine learning/deep learning module, feeds back and applies the new process variables again periodically to a control computer of the manufacturing process. The softsensor server 190 provides statistical data by big data analysis, and visualizes and outputs the statistical data, and the softsensor server 190 is connected to a LIMS/ERP/Legacy system 230.

For example, the soft sensor server 190 collects and stores online sensor data from a tester PC, which stores the online sensor data through the Ethernet or WLAN (Wi-Fi), through data communication, collects and stores, through data communication, inline sensor data measured by a measurement device of the inline sensor, and/or offline sensor data of a separate analysis device or dedicated analyzer 130 which is the offline sensor, and a data manager 137, outputs a result by applying new process variables (input) of the manufacturing process by using the machine learning/deep learning module 170, feeds back and applies the new process variables again periodically to a control computer of the manufacturing process, provides statistical data by analyzing accumulated big data, and visualizes and outputs the statistical data, and the softsensor server 190 is connected to a LIMS/ERP/Legacy system 230.

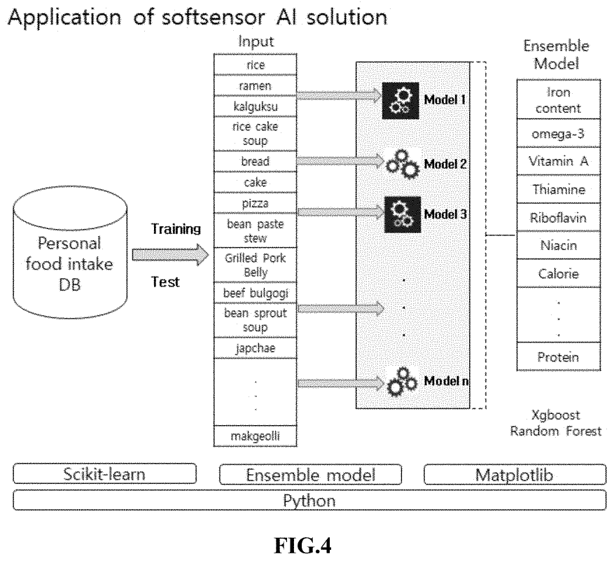

FIG. 4 is a view showing the configuration of a softsensor analysis and measurement system according to the present invention.

Using a Python development tool and machine learning modeling algorithm library (Scikit-learn), is used an ensemble model applied to a decision-making tree that applies a machine learning weight, a mathematical plot, and a Mathplot displayed as a graph.

For example, the soft sensor analysis and measurement system trains the individual food taking process of a person for one week to output proportions of dietary components in the individual food taking process of a person for one week by inputting information taken individual food (rice, ramen, kalguksu, rice cake soup, bread, cake, pizza, soybean paste stew, beef bulgogi, bean sprout soup, japchae, makgeolli or the like) and accumulating the dietary components (iron content, omega-3, or vitamin A, etc.) in an ensemble model in which weights are individually applied to a plurality of machine learning models (Model 1, Model 2, and Model 3).

The softsensor server 190 may collect and store corresponding learning data and detection data (online sensor data, measurement data of a measurement device of the inline sensor, measurement data of the dedicated analyzer of the inline sensor, or measurement data of the offline sensor), output learning data/detection data by data visualization, provide statistical information of individual data such as Z-score, mean, and standard deviation, provide daily/weekly/monthly statistical information after performing normal distribution, outputs a result by re-applying new process variables (input-temperature, humidity, or pressure etc.) of a manufacturing process by using the machine learning/deep learning module, and feeds back and applies the new process variables again periodically to a control computer of the manufacturing process.

Statistically, in the case of extracting an arbitrary sample of size n from a population, when distribution of the population follows a normal distribution

$$N ( m , \frac{{σ}^{2}}{n} ) ,$$

where the mean is m, and the standard deviation is σ, and when the sample mean of the arbitrary sample of size n is X and the standard deviation is σ, at the confidence level (95% confidence level) of the population mean m, the confidence interval is

$$[ X - 1.96 \frac{σ}{\sqrt{n}} , X + 1.96 \frac{σ}{\sqrt{n}} ] ,$$

and satisfies the condition of

$$X - 1.96 \frac{σ}{\sqrt{n}} \leq m \leq X + 1.96 \frac{σ}{\sqrt{n}} .$$

When the random variable X is a normal distribution (m,σ²),

$$z = \frac{X - m}{σ} ,$$

and the Z-score, mean, and standard deviation are calculated.

It is not limited to the embodiment, and there is provided a system for collecting and storing measurement values of online sensors (temperature sensors, humidity sensors, pressure sensors), inline sensors, and offline sensors (analysis devices, or dedicated analyzers) in the softsensor server, and predicting a machine learning/deep learning modeling result value by new process variables (input) of a manufacturing process, in a biopharmaceutical process, a smart factory manufacturing process, a food manufacturing process, and a steel manufacturing process.

Embodiments of the present invention may be implemented in the form of program instructions that can be executed by various computer means and recorded in a computer-readable recording medium. The computer-readable recording medium may store program instructions, data files, and data structures individually or in combination. The computer-readable recording medium may include hardware devices configured to store and execute program instructions in magnetic media such as storage, hard disks, floppy disks, and magnetic tapes, optical media such as CD-ROMs and DVDs, magneto-optical media such as floptical disks, and storage media such as ROM, RAM, flash memory, and the like. Examples of program instructions may include those generated by a compiler and high-level language codes that can be executed by a computer using an interpreter, as well as machine language codes. The hardware devices may be configured to operate by one or more software modules to perform the operations of the present invention.

As described above, the method of the present invention may be implemented as a program and stored in a recording medium (CD-ROM, RAM, ROM, memory card, hard disk, magneto-optical disk, storage device, or the like) in a form that can be read using computer software.

Although the present invention has been described with reference to a specific embodiment of the present invention, the present invention is not limited to the same configuration and operation as the specific embodiment to illustrate the technical spirit as described above, and within the limit that does not depart from the technical spirit and scope of the present invention, it can be implemented with various modifications, and the scope of the present invention should be determined by the claims described below.

1. A softsensor analysis and measurement system for deriving a result by new process variables on the basis of data collected by various sensors, the system comprising:
an online sensor, an inline sensor, or an offline sensor;
a machine learning/deep learning module; and
a softsensor server for collecting and storing online sensor data collected by the on-line sensor through a sensor network and a gateway, Ethernet, or WLAN (Wi-Fi), collecting and storing inline sensor data measured by an IoT device equipped with the inline sensor and/or offline sensor data measured by the offline sensor through an analysis device or dedicated analyzer, and outputting a result by applying new process variables (input) of a manufacturing process using the machine learning/deep learning module, and feeding back and applying the new process variables of the manufacturing process to a control computer of the manufacturing process.

2. The system of claim 1, wherein the online sensor includes a temperature sensor, a humidity sensor, or a pressure sensor.

3. The system of claim 1, wherein the inline sensor includes a sensor attached to an IoT device used in a manufacturing process.

4. The system of claim 1, the offline sensor includes an analysis device or a dedicated analyzer.

5. The system of claim 1, wherein the softsensor server collects and stores the online sensor data, the inline sensor data, and the offline sensor data, outputs the result by re-applying the new process variables (input) of the manufacturing process by using the machine learning/deep learning module, feeds back the new process variables of the manufacturing process to the control computer of the manufacturing process, provides statistical data by analyzing accumulated big data, visualizes and outputs the statistical data, and is connected to a LIMS/ERP/Legacy system.
